(19) United States
(12) Patent Application Publication
(10) Pub. No.: US 2023/0044182 A1
(43) Pub. Date: Feb. 9, 2023

(54) Graph Based Discovery on Deep Learning Embeddings

(71) Applicant: Microsoft Technology Licensing, LLC, Redmond, WA (US)

(72) Inventors: Robin Abraham, Redmond, WA (US); Leo Moreno Betthauser, Kirkland, WA (US); Maurice Diesendruck, Bellevue, WA (US); Urszula Stefania Chajewska, Issaquah, WA (US)

(21) Appl. No.: 17/389,039

(22) Filed: Jul. 29, 2021

(51) Int. Cl. G06N 3/08

(52) U.S. Cl. CPC G06N 3/08

(57) ABSTRACT

A computer implemented method includes obtaining deep learning model embedding for each instance present in a dataset, the embedding incorporating a measure of concept similarity. An identifier of a first instance of the dataset is received. A similarity distance is determined based on the respective embeddings of the first instance and a second instance. Similarity distances between embeddings, represented as points, imply a graph, where each instance's embedding is connected by an edge to a set of similar instances' embeddings. Sequences of connected points, referred to as walks, provide valuable information about the dataset and the deep learning model.

### BACKGROUND

Much of the data stored in enterprise systems is in unstructured formats, such as documents, meeting notes, audio recording, videos, pictures, etc. Only a small fraction of the data is in structured formats like SQL databases. Many enterprises invest in mining “knowledge” from structured and unstructured data and storing the information as knowledge graphs.

Creation and maintenance of knowledge graphs are complex endeavors that require significant investment in terms of expertise, time, effort, and money.

### SUMMARY

A computer implemented method includes obtaining a deep learning model embedding for each instance of data of a dataset. The embedding incorporates a measure of concept similarity. An identifier of a first instance of data of the dataset is received. A concept similarity distance is determined based on the respective embeddings of the first instance of data and a second instance of data.

Concept similarity distances imply a graph, where each instance of data is represented by a point in the graph and is connected by an edge to a set of nearby, or similar, points. Sequences of connected points, referred to as walks, in addition to a rich set of queries and constraints on those walks, provide valuable information about the dataset and the deep learning model.

### BRIEF DESCRIPTION OF THE DRAWINGS

FIG. 1 is a block diagram of a system for exploration of deep learning embeddings of instances of data present in the dataset to find relationships between the instances of the data according to an example embodiment.

FIG. 2 is a graph of a segment of points in a walk or path according to an example embodiment.

FIGS. 3A, 3B, and 3C are a graph illustrating full expansion of a walk between images of different types in an image set according to an example embodiment.

FIG. 4 is a flowchart of a computer implemented method for determining similarity of points present in the dataset using deep learning model embeddings according to an example embodiment.

FIG. 5 is a diagram illustrating further operations that may be performed based on embeddings according to an example embodiment.

FIG. 6 is a flowchart of a computer implemented method of providing a user perceivable display of a path according to an example embodiment.

FIG. 7 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Many enterprises invest in mining “knowledge” from structured and unstructured data and storing the information as knowledge graphs. The schema for a knowledge graph captures the entities as nodes, and relationships as edges between the nodes. The creation and maintenance of knowledge graphs to capture all the data in an enterprise can be complicated, time consuming, and expensive.

Crafting useful, ad-hoc, exploratory queries on a knowledge graph requires knowledge of the query language (or any custom user interface deployed on the knowledge graph engine). An end user who is directly interacting with the graph database engine would also need to understand the knowledge graph schema, including entities and relationships that have been captured, to be able to write useful queries. Entities and relationships that have not been explicitly encoded in the schema and populated as nodes and edges in the knowledge graph cannot be queried.

The present inventive subject matter utilizes one or more deep learning models to obtain embeddings for selected instances of data of one or more classes of instances of data present in a dataset. A similarity graph may be generated based on these embeddings The similarity graph has instances of data represented as points with edges between points representing similarity between the instances of data corresponding to the points. The embeddings incorporate a measure of data type or concept similarity that provides a unified view of a joint embedding space. Tools are provided to enable exploration of embedding spaces in efficient and informative ways to discover relationships between the instances of data present in the dataset.

While many deep learning models produce embeddings in a vector space, most models represent similarity only for local regions of the space. Model knowledge is better represented by a sense of local connectivity, i.e., by a manifold. For this reason, graph-based approximations and traversals can provide new and different value and can generalize more effectively for known and unknown data.

Embeddings are low-dimensional representations of the entities or concepts in the instances of data and corresponding relations induced by a similarity metric. Embeddings provide a generalizable context about the overall similarity graph that can be used to infer relations. In a larger and more dense similarity graph, embeddings may, for example, provide insights about molecular property interactions to accelerate drug discovery or cluster user behaviors of scammers in a gaming network. Such embeddings may be generated for a wide variety of different types of datasets.

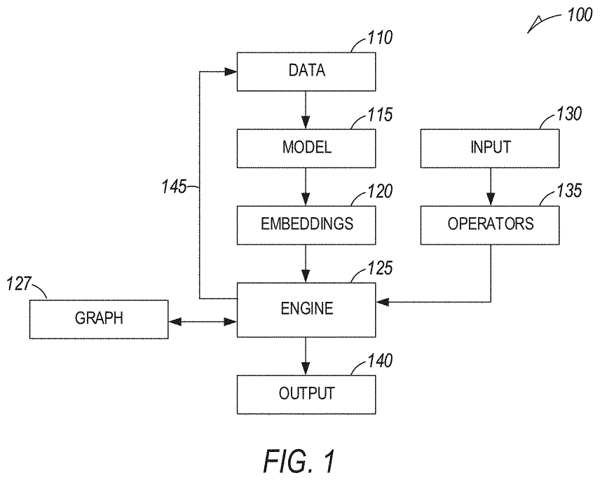

FIG. 1 is a block diagram of a system 100 for obtaining embeddings from data 110 and enabling exploration of the embeddings to find relationships between instances of the data 110. Data 110 may include structured data as well as unstructured data. Examples of unstructured data include documents and images which generally do not contain metadata identifying a relationship with other data.

A model 115 is used to create embeddings 120. An engine 125 may be used to perform operations on the embeddings 120, which may be represented as a similarity graph 127 having instances of data represented as points with edges between points representing similarity between the instances of data corresponding to the points. In some examples, the embeddings may be previously generated and obtained from storage for use by the engine 125.

Input 130 may be received using operators 135 to cause the engine 125 to perform various operations on the embeddings, such as walks or paths between two points corresponding to instances of the data 110 and provide an output 140 to visualize relationships between the points corresponding to instances of the data. Multiple operators are described in further detail below. The visualization may include actual data itself, such as images or text, as the embeddings may include or have associated identifiers of the corresponding data which can be retrieved by the engine 125 at 145.

The embeddings are computed so that they satisfy certain properties, for example, following a given knowledge graph model. In one example, the embeddings are taken from a selected layer of a deep learning model and may comprise up to 2048 floating point numbers or more depending on the model. The layer selected for the embeddings may vary, but typically is either near the middle or near the end of the deep learning model. Each model may define a different score function from which a measure of a distance of two instances of data relative to instance relation types in the low-dimensional embedding space may be calculated. These score functions are used to train the models so that the instances of data having points connected by relations have embeddings that are close to each other while the points that are not connected have embeddings that are far away.

In one example, once embeddings have been generated for a dataset, a concept similarity distance between two points may be determined from their respective embeddings to help identify relationships between the points. Representations, such as images and text of the instances, may also be displayed via a user interface to visually show relationships between points in a manner perceivable by a human user. In a further example, a path between two points comprising multiple points may be identified and displayed as a function of point similarities in the embeddings The identification of such a path is referred to as a walk or path between source and target points. Selected types of points may be excluded or filtered from the path.

An embedding is a relatively low-dimensional space into which high-dimensional vectors are translated. Embeddings capture some of the semantics of the input by placing semantically similar inputs close together in an embedding space.

Embeddings are created from deep learning models. Deep learning models convert an input (like an image) into a numerical representation, i.e. a sequence of numbers. To begin this procedure, the inputs are pre-processed into a numerical form—for example, images are encoded as a list of pixel values for each position in the image. That numerical form goes through a sequence of matrix multiplications, and eventually results in a final numerical representation. The model “learns” by defining some goal (for example, classify cat images as “Cat” and dog images as “Dog”), and adjusts the values in each matrix, to satisfy the goal. This framework is general and can be applied to make numerical representations for any input, and for any goal.

Note that the goal need not be given in the form of external labels (“Cat” and “Dog”). In the purely unsupervised case, a deep learning model may be constructed with an architecture consisting of an encoder that transforms the input over several layers into a latent representation (embeddings) of lower dimensionality and a decoder that takes the latent representation and outputs results of the same the dimension as the input. The goal in this case is to reconstruct the original input as faithfully as possible. In case of word embeddings trained on a document corpus, a commonly used goal is to fill in masked words in input sentences.

The concept similarity distance is a mathematical calculation done on two embeddings. The type distance metric used may be chosen by the user from a set of suitable distance measures that operate on vectors. The type of distance calculation to use may be specified along with embeddings. If not specified, a default distance metric may be used. One common distance that may be used is a Euclidean distance. Other distance functions may alternatively be used. Given a population of points (instances of the data), if one point is selected as a Query, the distance between the Query and all other points may be computed with the results being sorted. The point with the smallest distance from the one point is the first Nearest Neighbor. The point with the next smallest distance is the next Nearest Neighbor. Connecting each point with, for example, five of its nearest neighbors results in a graph comprising a set of points and edges. The edges are labeled with distances, enabling the use of known algorithms to find shortest paths between two points. One common algorithm for shortest path is Dijkstra's algorithm. Any distance algorithm or shortest path algorithm may be used.

A visualization of the relationship between two points may be created by displaying the original raw input associated with each point. Each point is given a unique Point ID, an Embedding, and a Raw Input (e.g. image, text, other object). The system defines paths in terms of Point IDs. To build visualizations, the system uses the sequence of Point IDs to assemble the associated sequence of Raw Inputs. For images, the Raw Input can be the image file object. For text, it could be the raw text to be displayed.

The distance (cost) of a step in the walk could be high either because the corresponding concepts (one may be a dog and the other a cat in the case of images) are far apart in embedding space or if enough examples are not present in the data to bridge the gaps. As more data (across a wider distribution) is made available to the system, the distances start to reflect actual dissimilarity between concepts.

A domain expert using the system may also provide feedback that two concepts are actually related, and the system would incorporate that information in generating the walks. The system maintains a graph object, which stores point and edge information for each instance of data in the dataset. Feedback can be incorporated, and thereby affect walks and other functions, by introducing or removing nodes, by introducing or removing edges between existing points, or by modifying the weights of existing edges.

An example of a walk between two points is described with respect to a dataset comprising several images starting with a point (image) representing the concept of pizza and ending with a point having an image representing the concept of umbrella.

Embeddings of the images created by a model are representative of the corresponding visual concepts. There is a distance associated with each hop from one point to the next. The walk is the system-inferred shortest path of hops from the source concept of pizza to the target concept of umbrella. While visual concepts, and this specific visualization, are used, the system is applicable to many different types of concepts.

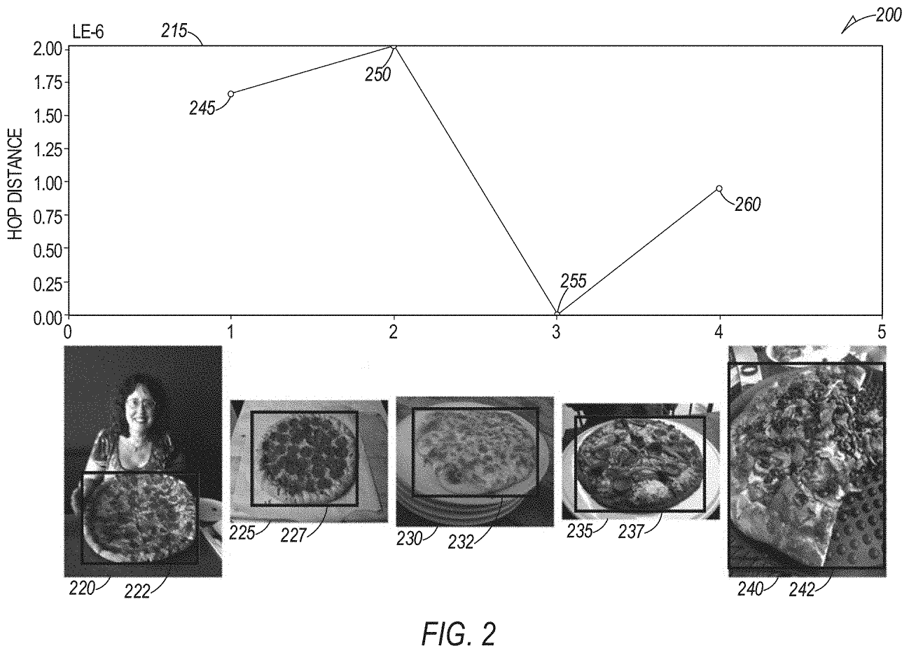

A view of the first four hops in the walk between the images, starting with pizza, are shown in FIG. 2 generally at 200. All the images actually include pizza, so the hop distances shown in a plot line 210 are fairly small. The y-axis 215 has been scaled to show hop distances of between 0.00 and 2.00. The scale for the entire set of images is relative and for example, may be between 0.00 and 10.00. Note that the scale can be any range of numbers, such as 0 to 100 in further examples.

Images 220, 225, 230, 235, and 240 are shown along the x-axis with the plot line 210 illustrating the hop distance between the images. For example, the distance of the hop between images 220 and 225 is shown at 245. Both of these images show an entire pizza as illustrated by respective bounding boxes 222 and 227. Bounding boxes 232 and 237 also show entire pizzas, while bounding box 242 illustrates less than an entire pizza.

The distance of the hop represented at 245 is relatively high for a transition between the same concept of pizza. Perhaps the type of pizza and surface behind the pizzas in each contributed to this relatively high hop. The distance of the hop at 250 is slightly higher, as the image 230 is much lighter and has less overall contrast and does not have a significant number of round slices of pepperoni. The toppings of image 230 are somewhat irregular, which may be why the distance of the hop at 255 is low, as the toppings of image 235 are also somewhat irregular. The differences noted above are not necessarily those that contributed to the embeddings and calculated distances but are merely those visually observed by a human.

The following information has been displayed in FIG. 2:
Step number or position. (positions 0-4)
a. Distance (245, 250, 255, 260) of plot line 210.
b. File name (data id) (file numbers with a JPG extension)
c. Recognized visual concept (e.g., pizza), identified as a label.
d. The actual image (220, 225, 230, 235, and 240) that contains the recognized visual concept

The hop distances of the first four steps (across 5 images, with y-axis rescaled) Error! Reference source not found. are negligibly small, since pizza is the dominant visual concept recognized in the images.

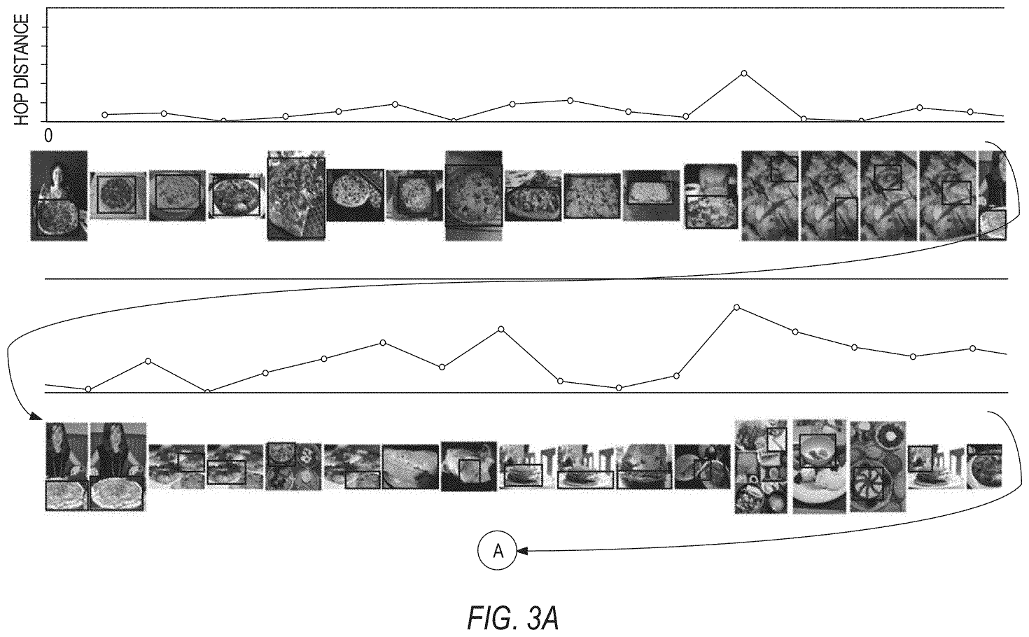

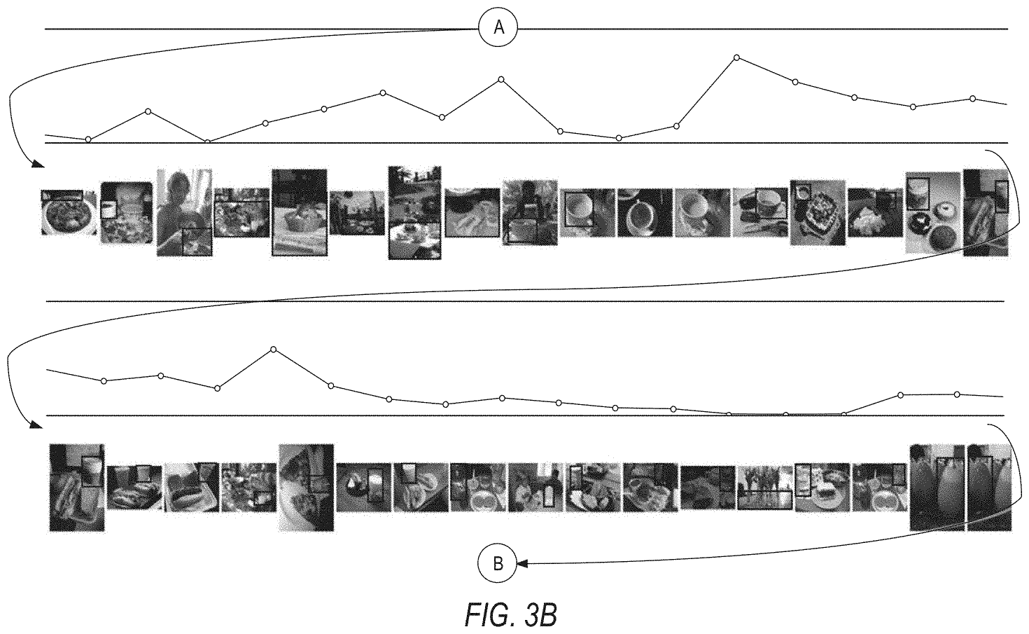

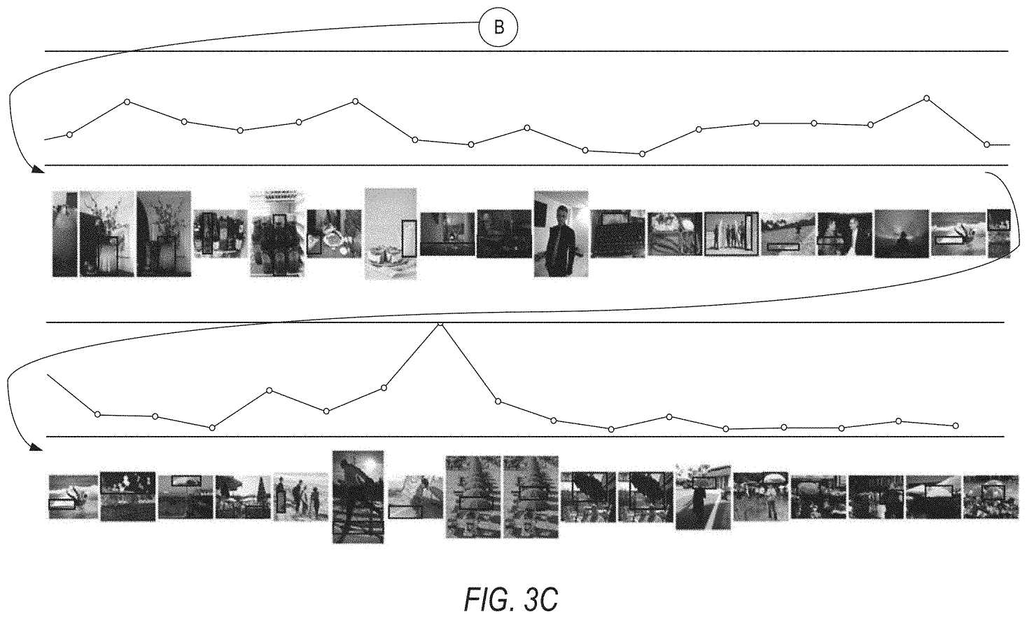

FIGS. 3A, 3B, and 3C are a graph 300 illustrating full expansion of a walk from pizza (image 220) to umbrella (image 310) in the original image set. Graph 300 is broken up over multiple lines. Images 220, 225, 230, 235, and 240 from FIG. 2 are shown at the top left of FIG. 3. The hop distance y-axis 315 scale is greatly increased from that of FIG. 3 due to the many different concepts or types of images included in the dataset.

The low distance for the first four hops is apparent when compared with many of the cross-concept hops (for example, the peak 320 in the last row where the traversal crosses over from “surf board” image 325 to “umbrella”) image 310 that have higher hop distances.

In this example, the source has been specified as the specific image with pizza and the target as the image with the umbrella, in order to explore the walk(s) between them. Given a set of system-inferred paths, the shortest path might be most relevant when a lot of data are available, and the cost/distance of the walk reflects “reality” (the similarity between the visual concepts in the real world). Alternate paths might be interesting or even more relevant when the data is sparse, especially at the cross-over boundaries between concepts/entities.

Several operators 135 are supported by engine 125. The operators allow users to describe traversals of the embedding space. Such operators may be provided by any programming interface, such as input 130 for either selecting operators from a menu or writing operator-based queries for execution by engine 125. In some examples, translation to an intermediate representation may be performed before the engine 125 executes the query and fetches results from embeddings.

Once the data has been processed to generate the embeddings, a user may select source and target instances that appear in any of multiple data sources (research publications, lab reports, doctors' notes, patent filings, etc.) and have the engine 125 generate walks or paths between them. A user is able to interact with the generated walks and prune hops that do not make sense from a domain or application point of view, and the system 100 may learn from the feedback.

A set of constraints may be expressed, either through UX (user experience) mechanisms or through logical expressions, to limit explorations to walks that satisfy the constraints. The following examples show how this capability can be supported.

In one example, walks are limited to less than hₙ number of steps or to h_{d} total hop distance between source and target points: hₙ<N ∨ h_{d}<D. Both kinds of limits can be generically called “Conceptual Budget”.

In another example, multi-hop walks are generated from source s to target t, but without including concept c: s->>t ∧ [symbol] c.

All possible walks from source point s to target point t are generated, that contain entity c immediately after s and are under N steps: s->c->>t ∧ hₙ<N.

Generate walks that start with s and contain points a, b or c along the way and are under total hop distance D in length. The target point has not been specified, resulting in all walks that end at any target point and satisfy the other specified criteria being valid results: s->>(a|b|c)->>*∧ h_{d}<D.

Walks are also objects with properties and can be queried for membership. For example, given that t_{b} is similar to, or at least in the same neighborhood as tₐ, a user can repeat the analyses to find the overlap and differences in the generated walks s->>tₐ and s->>t_{b}.

The above examples illustrate constraints on actual instances. Constraints on concepts (data types) may be supported by adding a function e that takes a point as input and returns the concept or data type. This capability may be provided by augmenting the underlying data with additional information like ontologies. e (a) returns the data type (concept) of which a is an instance.

The following examples demonstrate cases where this new function adds to the expressiveness of the traversals. In one example, all single hop walks may be generated that begin at point s and end at any point e(t): s->e(t). In another example, walks may be generated that start with point s, end at target point t, and include any points of the parent type of a: s->>e(a)->>t.

In many real-world applications, points do not always just belong to a single data type or class. Multiple inheritance may be encountered in the schema. In the general case, e (a) will not return a single data type. Instead, it will return a set of data types that the point a belongs to. In this case, the traversal s->>e(a)->>t will generate walks that start with point s and end at target point t and includes any points from all the data types e(a).

Queries that allow multiple inheritance lookups might generate too many traversals as outputs. To constrain the results, lookups can be avoided by providing specific data types as part of the query: Generate walks that start with point s, end at target point t, and include any points of data type eₐ: s->>eₐ->>t.

Expanding on the previous example, traversals can be generated using queries that only contain data types (no points): Generate walks that include any points of specified types: eₛ->>eₐ->>eₜ.

Operators on walks enable more exploration. The capability is illustrated through a few more operators. Let a be a single point, and let w be a single walk: Contains (w, a) is True when the walk contains a point the data type a, and is False otherwise.

Several relaxations can be useful: A ContainsSoft version that considers any point within a radius of points along the walk. A ContainsSet version that considers proximity to any element in a target set and returns a list of items from the target set that are sufficiently close. SubsetByType (w, eₐ) returns a list of points in a walk, who match the given entity type.

SampleRandomWalk(a, n, max_hops) returns a list of n random walks that start from point a, each with a maximum number of hops. This function can be used to sample and study the characteristics of walks that originate at a, or to extend the radius of explorations for a set of walks that end at a.

Find nearest neighbors, with option to search only neighbors of a given type. NearestNeighbors (a, type=eₐ, dist=d) returns a list points similar to a, of type eₐ, and at maximum distance d. Note that this is the functional representation of the equivalent expression in operator syntax: a->>e(a) ∧ h_{d}<d

In one example, a pharma domain is used to illustrate how the embeddings facilitate exploration and discovery. The pharma domain is fairly complex and includes multiple instances of data that have non-obvious relationships between them. Here are a few examples of deep entities from the Pharma domain:
Drug molecules and drug families
Diseases
Drug targets
Drug treatment
Side effects
Genes
Patient demographics
Patient medical history
Drug interactions
Food interactions

The diverse entities listed above may be extracted from a wide variety of unstructured and structured data sources like molecule simulations and lab experiments, research publications, clinical trial protocols and operational data, Electronic Health/Medical Records (EHR/EMR), patient forums, regulatory guidelines, textbooks, handbooks, and patent filings.

Drug and Symptom may be considered different classes of points, while Prevents and Induces could be considered different classes of edges in the similarity graph.

The term “aspirin” is an instance of data present in the input data. An embedding of this instance of data may be represented as a point in the similarity graph. A walk from “aspirin” to “headache” may be easily found in the graph.

In many of the interactions described below with embeddings created by one or more deep learning models, it is also possible to generate nonsensical traversals since the system is meant to support discovery through explorations. Explorations of the embedding space can be done iteratively, and subject matter experts can provide feedback and refine the traversals and select those that make sense for specific domains and target applications.

Examples of traversals using the described operators illustrate the power of the approach. In a first example, the likelihood of specific adverse reactions is provided. Given a starting point (e.g. a drug treatment), the likelihood of target (e.g. side effect) can be approximated using graph traversal, by computing the proportion of random walks (of a specified budget) that contain the target may be found by the following query:

```
walks = SampleRandomWalks(treatment, n=100, max_hops=25)
counter = 0
for walk in walks:
  if Contains(walk, effect):
    counter += 1
prob_effect_given_treatment = counter / len(walks)
```

The graph traversals can also be extended to include demographic attributes. The generated samples can then be aggregated (sum/average over group-by) to estimate the incidence of specific drug side effects in sub populations.

In a second example, other drug alternatives that avoid side effects may be discovered, A search for alternative drugs that avoid side effects can be accomplished by (1) investigating similar drugs in the embedding space, (2) querying all walks between each drug to the desired outcome, (3) filtering resulting walks based on user-provided criteria: side_effect=. . .

```
candidates = NearestNeighbors(initial_drug, type=drug)
alternatives = [ ]
for candidate in candidates:
  walk = candidate −>> outcome
  if not Contains(walk, side_effect):
    alternatives.append(candidate)
```

In a third example, given a drug intended for one outcome, e.g. reduced blood pressure, other possible desirable outcomes that are nearby in the space may be found:

```
  desirable_outcomes = [increased lung capacity, reduced
inflammation, ...]
  walk = drug −>> original_outcome
  good_outcomes = ContainsSet(walk, desirable_outcomes)
  for outcome in good_outcomes:
    w = drug −>> outcome
```

One can now view the path identified and investigate the path between drug and new outcome that has been found.

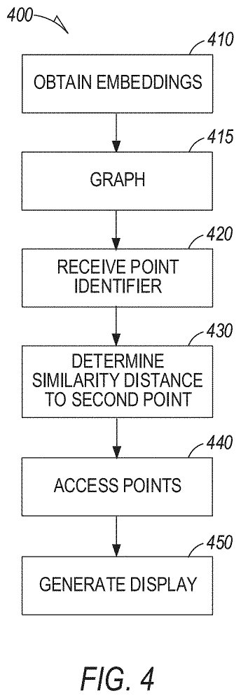

FIG. 4 is a flowchart of a computer implemented method 400 for determining similarity of instances of data present in the dataset in a dataset using deep learning model embeddings. Method 400 begins at operation 410 by generating deep learning model embedding for each of multiple instances of the dataset. The embeddings incorporate a measure of concept similarity of the instances. The embeddings may be pre-generated in some examples and effectively generated by retrieving the already generated embeddings. At operation 415, the dataset is represented in a similarity graph having instance of data represented by points and similarity represented by edges between the points.

An identifier of a first point in the similarity graph is received at operation 420. The identifier may be a file name that is associated with the corresponding embedding of the corresponding instance of data.

Operation 430 determines a concept similarity distance from the first point to a second point based on the respective embeddings of the first and second instances of data corresponding to the points. In one example, the similarity distance comprises a Euclidean distance between the respective embeddings.

In one example, method 400 may continue by accessing the first and second points at operation 440 based on their respective embeddings. Operation 450 displays content representative of the first and second points along with an indication of the similarity distance between the first and second points.

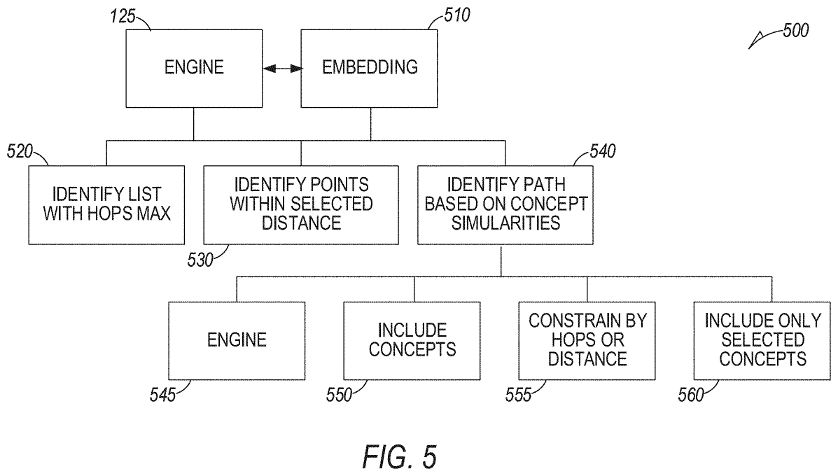

FIG. 5 is a diagram illustrating further operations generally at 500 that may be performed based on the embeddings shown at 510. Such functions may be performed by engine 125. Operation 520 progressively identifies a list of points from the first point to a target point, the list including points representing a fewest number of hops to progress from the first point to the target point. Operation 530 identifies a list of points within a selected similarity distance from the first point.

Operation 540 identifies a path between the first and second points as a function of concept similarities in the embeddings. The path may be expressed in the form of a queryable object. Operation 540 may exclude selected concepts from the path at 545. All points of all concept types may be included at 550. The path may be constrained to a number of hops or a total distance between the first and second points at 555. At 560, the path may include only points of specified concepts.

In one example, operations performed by engine 125 may include obtaining a deep learning model embedding for each instance of data of multiple instances of a dataset, together with a distance measure applicable to vectors, representing the dataset in a similarity graph having instances of data represented by points and similarity represented by edges between points according to the specified distance measure, receiving an identifier of a first point in the similarity graph, and determining a similarity distance based on the respective embeddings of the first point and a second point using the specified distance measure.

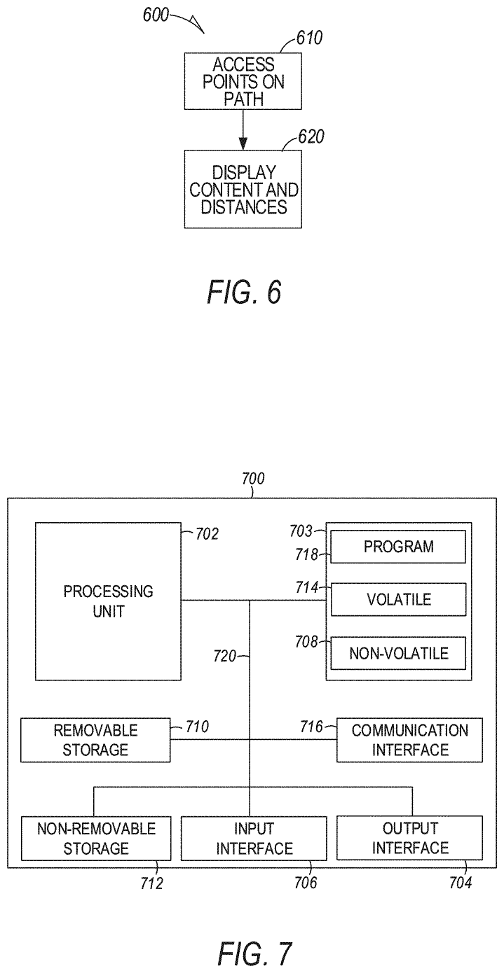

FIG. 6 is a flowchart of a computer implemented method 600 of providing a user perceivable display of a path. Method 600 begins at operation 610 by accessing points on the path that has been created. Operation 620 displays content representative of the instances along with an indication of the similarity distance between successive points. One example of such a display is shown at 200 in FIG. 2, an includes the plot line 210 indicating the similarity distance.

FIG. 7 is a block schematic diagram of a computer system 700 to create embeddings for instances of a dataset and for using the embeddings to create a similarity graph and use the graph to identify and explore relationships between the points as well as for performing methods and algorithms according to example embodiments. All components need not be used in various embodiments.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 along with the workspace manager 722 may be used to cause processing unit 702 to perform one or more methods or algorithms described herein.

### EXAMPLES

1. A computer implemented method includes obtaining a deep learning model embedding for each instance of data of a dataset, the embedding incorporating a measure of concept similarity, representing the dataset in a similarity graph having instances of data represented by points and similarity represented by edges between points, receiving an identifier of a first point in the similarity graph, and determining a concept similarity distance based on the respective embeddings of the first point and a second point.

2. The method of example 1 and further including accessing the first and second points based on their respective embeddings and displaying content representative of the first and second points.

3. The method of any of examples 1-2 wherein the similarity distance includes a Euclidean distance between the respective embeddings.

4. The method of any of examples 1-3 and further including progressively identifying a list of points from the first point to a target point, the list including points representing a fewest number of hops to progress from the first point to the target point.

5. The method of any of examples 1-4 and further including identifying a list of points within a selected similarity distance from the first point.

6. The method of any of examples 1-5 and further including progressively identifying a path between the first and second points as a function of concept similarities in the embeddings.

7. The method of example 6 wherein identifying a path includes excluding selected concepts from the path.

8. The method of example 6 wherein identifying a path includes including all points of all concept types.

9. The method of example 6 wherein identifying a path includes constraining the path to a number of hops or a total distance between the first and second points.

10. The method of example 6 wherein identifying a path includes including points of specified concepts in the path.

11. The method of example 6 wherein the path includes a queryable object.

12. The method of example 6 and further including accessing points on the path and displaying content representative of the instances of data corresponding to the points along with an indication of the similarity distance between successive entities.

13. A machine-readable storage device has instructions for execution by a processor of a machine to cause the processor to perform operations to perform any of method of examples 1-12.

20. A device includes a processor and a memory device coupled to the processor and having a program stored thereon for execution by the processor to perform operations to perform any of method of examples 1-12.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
obtaining a deep learning model embedding for each instance of data of a dataset, the embedding incorporating a measure of concept similarity;
representing the dataset in a similarity graph having instances of data represented by points and similarity represented by edges between points;
receiving an identifier of a first point in the similarity graph; and
determining a concept similarity distance based on the respective embeddings of the first point and a second point.

2. The method of claim 1 and further comprising:
accessing the first and second points based on their respective embeddings; and
displaying content representative of the first and second points.

3. The method of claim 1 wherein the similarity distance comprises a Euclidean distance between the respective embeddings.

4. The method of claim 1 and further comprising progressively identifying a list of points from the first point to a target point, the list including points representing a fewest number of hops to progress from the first point to the target point.

5. The method of claim 1 and further comprising identifying a list of points within a selected similarity distance from the first point.

6. The method of claim 1 and further comprising progressively identifying a path between the first and second points as a function of concept similarities in the embeddings.

7. The method of claim 6 wherein identifying a path comprises excluding selected concepts from the path.

8. The method of claim 6 wherein identifying a path comprises including all points of all concept types.

9. The method of claim 6 wherein identifying a path comprises constraining the path to a number of hops or a total distance between the first and second points.

10. The method of claim 6 wherein identifying a path comprises including points of specified concepts in the path.

11. The method of claim 6 wherein the path comprises a queryable object.

12. The method of claim 6 and further comprising:
accessing points on the path; and
displaying content representative of the instances of data corresponding to the points along with an indication of the similarity distance between successive entities.

13. A machine-readable storage device having instructions for execution by a processor of a machine to cause the processor to perform operations to perform a method, the operations comprising:
obtaining a deep learning model embedding for each instance of data of a dataset, the embedding incorporating a measure of concept similarity;
representing the dataset in a similarity graph having instances of data represented by points and similarity represented by edges between points;
receiving an identifier of a first point in the similarity graph; and
determining a concept similarity distance based on the respective embeddings of the first point and a second point.

14. The device of claim 13 and further comprising:
accessing the first and second points based on their respective embeddings; and
displaying content representative of the first and second points.

15. The device of claim 13 and further comprising progressively identifying a list of points from the first point to a target point, the list including points representing a fewest number of hops to progress from the first point to the target point.

16. The device of claim 13 and further comprising progressively identifying a path between the first and second points as a function of concept similarities in the embeddings.

17. The device of claim 16 wherein identifying a path comprises at least one of excluding selected concepts from the path, including all points of all concept types, constraining the path to a number of hops or a total distance between the first and second points, and including points of specified concepts in the path.

18. The device of claim 16 wherein the path comprises a queryable object.

19. The method of claim 16 and further comprising:
accessing points on the path; and
displaying content representative of the instances of data corresponding to the points along with an indication of the similarity distance between successive entities.

20. A device comprising:
a processor; and
a memory device coupled to the processor and having a program stored thereon for execution by the processor to perform operations comprising:
obtaining a deep learning model embedding for each instance of data of a dataset, the embedding incorporating a measure of concept similarity;
representing the dataset in a similarity graph having instances of data represented by points and similarity represented by edges between points;
receiving an identifier of a first point in the similarity graph; and
determining a concept similarity distance based on the respective embeddings of the first point and a second point.
